(19) United States
(12) Patent Application Publication
(10) Pub. No.: US 2014/0126176 A1
(43) Pub. Date: May 8, 2014

(54) PROTECTIVE COVER AND KEYBOARD

(71) Applicants: DARFON ELECTRONICS CORP., Taoyuan (TW); DARFON ELECTRONICS (SUZHOU) CO., LTD., Suzhou (CN)

(72) Inventors: Liang-Yu Yao, Taoyuan (TW); Hsin-Cheng Ho, Taoyuan (TW); Hsuan-Wei Ho, Taoyuan (TW)

(73) Assignees: DARFON ELECTRONICS CORP., Taoyuan (TW); DARFON ELECTRONICS (SUZHOU) CO., LTD., Suzhou (CN)

(21) Appl. No.: 14/065,446

(22) Filed: Oct. 29, 2013

(30) Foreign Application Priority Data
Nov. 2, 2012 (TW) 101221301

(51) Int. Cl. F21V 8/00

(52) U.S. Cl. CPC G02B 6/006
USPC 362/23.03; 362/607

(57) ABSTRACT

A protective cover includes a light guide plate, a first flexible layer, a light masking layer and a light source. The light guide plate has a light scattering structure, an upper surface and a lower surface opposite to the upper surface, wherein the light scattering structure is formed in the light guide plate and adjacent to the lower surface. The first flexible layer is formed on the upper surface. The light masking layer is formed on the first flexible layer and has a light transmissible portion formed over the light scattering structure correspondingly. The light source is disposed neighboring to the light guide plate and light emitted by the light source is guided by the light guide plate and then emitted out of the light transmissible portion.

### BACKGROUND OF THE INVENTION

1. Field of the Invention

The invention relates to a protective cover and a keyboard and, more particularly, to a protective cover with dustproof function, waterproof function and light emitting function and a keyboard equipped with the protective cover.

2. Description of the Prior Art

A keyboard, which is the most common input device, can be found in variety of electronic equipments for users to input characters, symbols, numerals and so on. From consumer electronic products to industrial machine tools are all equipped with a keyboard for purpose of operation.

As technology advances, there are many types of keyboards in use . Users pay much more attention to visual effect of keyboard except basic input function while choosing keyboard. So far an illuminated keyboard has been developed. The illuminated keyboard attracts users in visual effect and can be used in darkness. Therefore, the illuminated keyboard becomes more and more competitive.

The illuminated keyboard is usually equipped with a backlight module for emitting light. The backlight module comprises a light guide plate and a light source. The light source is disposed neighboring to the light guide plate and used for emitting light into the light guide plate, such that the light is guided by and emitted out of the light guide plate. In general, the backlight module is undetachably disposed below a baseplate of a keyboard, such that the size of the keyboard increases a lot and it is unfavorable to miniaturize the keyboard.

### SUMMARY OF THE INVENTION

An objective of the invention is to provide a protective cover with dustproof function, waterproof function and light emitting function and a keyboard equipped with the protective cover, so as to solve the aforesaid problems.

According to an embodiment of the invention, a protective cover comprises a light guide plate, a first flexible layer, a light masking layer and a light source. The light guide plate has a light scattering structure, an upper surface and a lower surface opposite to the upper surface, wherein the light scattering structure is formed in the light guide plate and adjacent to the lower surface. The first flexible layer is formed on the upper surface, and a refractive index of the first flexible layer is smaller than a refractive index of the light guide plate and larger than a refractive index of air. The light masking layer is formed on the first flexible layer. The light masking layer has a light transmissible portion formed over the light scattering structure correspondingly. The light source is disposed neighboring to the light guide plate. Light emitted by the light source is guided by the light guide plate and then emitted out of the light transmissible portion.

According to another embodiment of the invention, a keyboard comprises a baseplate, a plurality of keyswitches and a protective cover. The keyswitches are disosed on the baseplate and the protective cover is disposed on the keyswitches. The protective cover comprises a light guide plate, a first flexible layer, a light masking layer and a light source. The light guide plate has an upper surface and a lower surface opposite to the upper surface. The first flexible layer is formed on the upper surface. The light masking layer is formed on the first flexible layer. The light masking layer has a plurality of light transmissible portions formed over the keyswitches correspondingly. The light source is disposed neighboring to the light guide plate. Light emitted by the light source is guided by the light guide plate and then emitted out of the light transmissible portions.

As mentioned in the above, when the protective cover of the invention is disposed on the keyswitches, the protective cover covers the gaps between the keyswitches to prevent particles, dust, liquids or the like from entering the interior of the keyboard through the gaps, so as to achieve dustproof function and waterproof function. In addition to dustproof function and waterproof function, the protective cover of the invention further has light emitting function. When the protective cover of the invention is disposed on the keyswitches, the keyboard becomes an illuminated keyboard, so as to enhance visual effect in use. Since the protective cover with light emitting function can be detached from the keyboard, it is favorable to miniaturize the keyboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a keyboard according to an embodiment of the invention.

FIG. 2 is a partial exploded view illustrating the keyboard shown in FIG. 1.

FIG. 3 is a cross-sectional view illustrating the keyboard along line X-X shown in FIG. 1.

FIG. 4 is a partial cross-sectional view illustrating a keyboard according to another embodiment of the invention.

FIG. 5 is a partial cross-sectional view illustrating a protective cover according to another embodiment of the invention.

### DETAILED DESCRIPTION

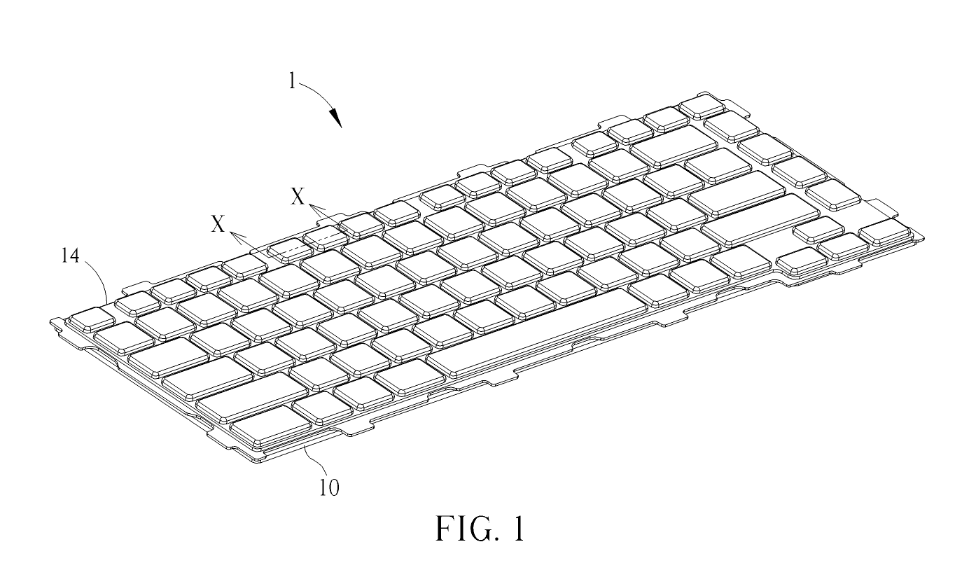

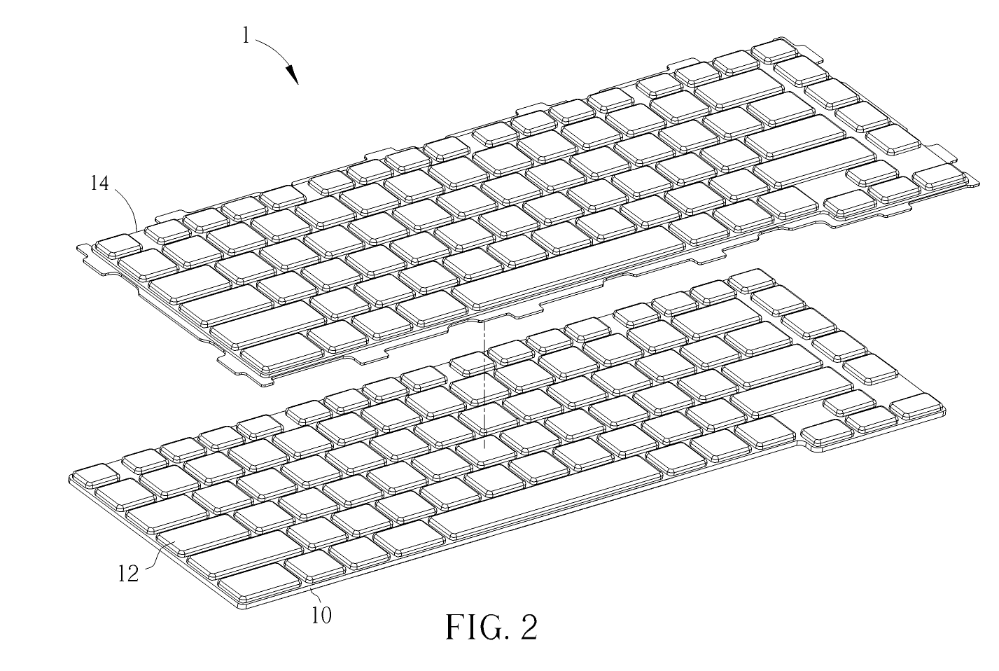

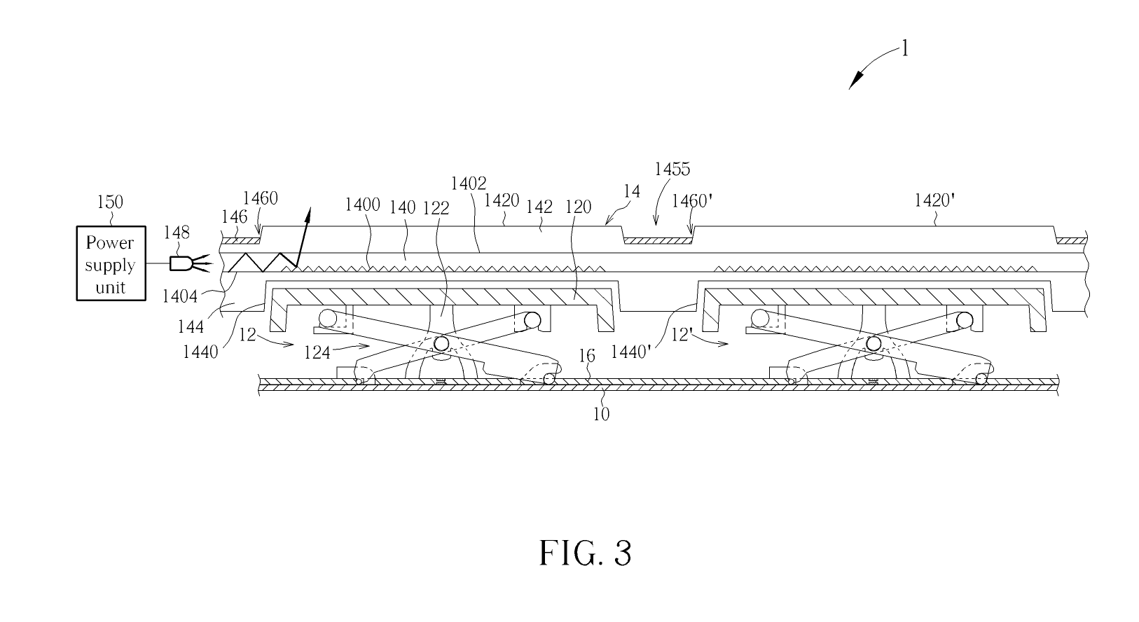

Referring to FIGS. 1 to 3, FIG. 1 is a schematic view illustrating a keyboard 1 according to an embodiment of the invention, FIG. 2 is a partial exploded view illustrating the keyboard 1 shown in FIG. 1, and FIG. 3 is a cross-sectional view illustrating the keyboard 1 along line X-X shown in FIG. 1. As shown in FIGS. 1 to 3, the keyboard 1 comprises a baseplate 10, a plurality of keyswitches 12 and a protective cover 14. Each of the keyswitches 12 is disposed on the baseplate 10 for a user to press, so as to execute desired function correspondingly. The protective cover 14 is disposed on the keyswitches 12 and used to provide dustproof function, waterproof function and light emitting function.

As shown in FIG. 3, the keyboard 1 further comprises a circuit board 16 disposed between the baseplate 10 and the keyswitch 12. The keyswitch 12 comprises a key cap 120, a resilient member 122 and a lift support device 124, wherein the resilient member 122 and the lift support device 124 are disposed between the baseplate 10 and the key cap 120. When the keyswitch 12 is pressed, the key cap 120 will move toward the baseplate 10 along with the lift support device 124. The resilient member 122 is used to provide elastic force while the keycap 120 moves upward and downward with respect to the baseplate 10. The resilient member 122 may be, but not limited to, a rubber dome. The circuit board 16 has a switch corresponding to the keyswitch 12, wherein the switch maybe a membrane switch or other trigger-type switch. When the key cap 120 is pressed, the resilient member 122 triggers the switch of the circuit board 16, so as to execute desired function correspondingly.

As shown in FIG. 3, the protective cover 14 comprises a light guide plate 140, a first flexible layer 142, a second flexible layer 144, a light masking layer 146, a light source 148 and a power supply unit 150. The light guide plate 140 has alight scattering structure 1400, an upper surface 1402 and a lower surface 1404 opposite to the upper surface 1402, wherein the light scattering structure 1400 is formed in the light guide plate 140, corresponding to the keyswitch 12 and adjacent to the lower surface 1404. The first flexible layer 142 is formed on the upper surface 1402, and a refractive index of the first flexible layer 142 is smaller than a refractive index of the light guide plate 140 and larger than a refractive index of air. The second flexible layer 144 is formed below the lower surface 1404, and a refractive index of the second flexible layer 144 is smaller than the refractive index of the light guide plate 140 and larger than the refractive index of air. The light masking layer 146 is formed on the first flexible layer 142. The light masking layer 146 has a light transmissible portion 1460 formed over the keyswitch 12 correspondingly. The light source 148 is disposed neighboring to the light guide plate 140. Light emitted by the light source 148 is guided by the light guide plate 140, scattered by the light scattering structure 1400, and then emitted out of the light transmissible portion 1460 for the user to see. The power supply unit 150 is electrically connected to the light source 148 and used for supplying power for the light source 148. In practical applications, the power supply unit 150 maybe a battery. It should be noted that the number of light scattering structures 1400 and light transmissible portions 1460 are determined according to the number of keyswitches 12.

In this embodiment, the refractive index of the light guide plate 140 is between 1.4 and 2. Since the refractive index of air is 1, the refractive index of the light guide plate 140 may be, but not limited to, 1.5, the refractive index of the first flexible layer 142 formed on the upper surface 1402 of the light guide plate 140 maybe, but not limited to, 1.2, and the refractive index of the second flexible layer 144 formed on the lower surface 1404 of the light guide plate 140 may be, but not limited to, 1.2. It should be noted that the materials of the first flexible layer 142 and the second flexible layer 144 may be the same or different according to practical applications. For example, the light guide plate 140 may be made of, but not limited to, Polycarbonate (PC) or Polymethylmethacrylate (PMMA), and the first flexible layer 142 and the second flexible layer 144 may be made of, but not limited to, SiO₂ or TiO₂. Furthermore, the first flexible layer 142 and the second flexible layer 144 may be semi-transparent or fully transparent according to practical applications.

In this embodiment, the light scattering structure 1400 may be a character, a symbol, a letter or a combination thereof formed by a microstructure, an optical ink or a UV ink, such that the user can recognize the desired function of each keyswitch 12. In other words, when light emitted by the light source 148 is guided by the light guide plate 140 to the light scattering structure 1400, the light is scattered by the light scattering structure 1400 and then emitted out of the light transmissible portion 1460. At this time, the user can see the character, the symbol, the letter or the combination thereof formed by the light scattering structure 1400 from the light transmissible portion 1460. The light masking layer 146 can block the stray light around the light transmissible portion 1460, such that the user can recognize the character, the symbol, the letter or the combination thereof formed by the light scattering structure 1400 clearly. In this embodiment, the light masking layer 146 may be made of black ink or other light masking materials. Furthermore, a character, a symbol, a letter or a combination thereof may be formed on the first flexible layer 142 and corresponding to the light transmissible portion 1460 by an ink printing process, a laser engraving process or other processes, such that the user can recognize the desired function of the keyswitch 12 before the light source 148 emits light.

In this embodiment, the first flexible layer 142 may have protruding portions 1420, 1420′ exposed from the light transmissible portions 1460, 1460′ and corresponding to the keyswitches 12, 12′, as shown in FIG. 3. In other words, the protruding portions 1420, 1420′ and the light transmissible portions 1460, 1460′ are corresponding to the keyswitches 12, 12′, respectively. When the protective cover 14 is disposed on the keyswitch 12, the protruding portion 1420 can provide stroke feeling for the user as the key cap 120 of the keyswitch 12. Moreover, a concave space 1455 is formed between every two adjacent protruding portions 1420, 1420′, such that a user is able to distinguish different protruding portions 1420, 1420′ corresponding to different keyswitches 12, 12′ easily through the concave space 1455. The protruding portion 1420 may have a character, a symbol, a letter or a combination thereof formed by an ink printing process, a laser engraving process or other processes, such that the user can recognize the desired function of the keyswitch 12 before the light source 148 emits light.

Still further, the second flexible layer 144 may have recess portions 1440, 1440′ corresponding to the keyswitches 12, 12′. In other words, the recess portions 1440, 1440′ are corresponding to the keyswitches 12, 12′, respectively. When the protective cover 14 is disposed on the keyswitch 12, the recess portion 1440 covers the key cap 120, such that the protective cover 14 can be disposed on the keyboard 1 stably. Accordingly, the invention can prevent the protective cover 14 from coming off the keyboard 1 or restrain the protective cover 14 from moving leftward and rightward with respect to the keyboard 1 while the user presses the keyswitch 12.

Accordingly, when the protective cover 14 is disposed on the keyswitches 12, the protective cover 14 covers the gaps between the keyswitches 12 to prevent particles, dust, liquids or the like from entering the interior of the keyboard 1 through the gaps, so as to achieve dustproof function and waterproof function. In addition to dustproof function and waterproof function, the protective cover 14 further has light emitting function. When the protective cover 14 is disposed on the keyswitches 12, the keyboard 1 becomes an illuminated keyboard, so as to enhance visual effect in use. Since the protective cover 14 with light emitting function can be detached from the keyboard 1, it is favorable to miniaturize the keyboard 1. The flexible protective cover 14 should conform to the following criteria: 1) when the user presses the protruding portion 1420 of the protective cover 14 corresponding to one single keyswitch 12, parts of the protective cover 14 neighboring to the protruding portion 1420 can deform, so as to not influence the stroke feeling obviously; and 2) when the user removes his/her finger from the protruding portion 1420, the keyswitch 12 can raise the protruding portion 1420 back to the highest position smoothly due to the elastic force generated by the resilient member 122, so as to not increase additional delay time obviously.

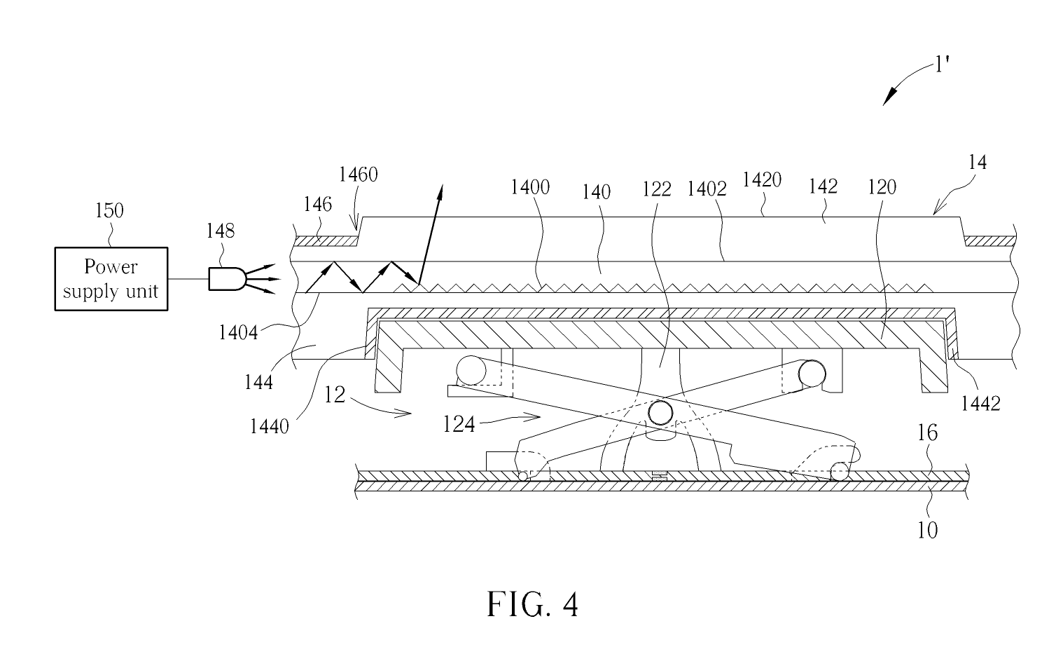

Referring to FIG. 4, FIG. 4 is a partial cross-sectional view illustrating a keyboard 1′ according to another embodiment of the invention. The difference between the keyboard 1′ and the aforesaid keyboard 1 is that the second flexible layer 144 of the keyboard 1′ further has a reflective layer 1442 formed below the light scattering structure 1400 correspondingly. In this embodiment, the reflective layer 1442 may be formed by white ink, silver paint or other light reflecting materials. The reflective layer 1442 can reflect light, which is scattered to the reflective layer 1442, so as to enhance the intensity of the light emitted out of the light transmissible portion 1460. It should be noted that the same elements in FIG. 4 and FIG. 3 are represented by the same numerals, so the repeated explanation will not be depicted herein again.

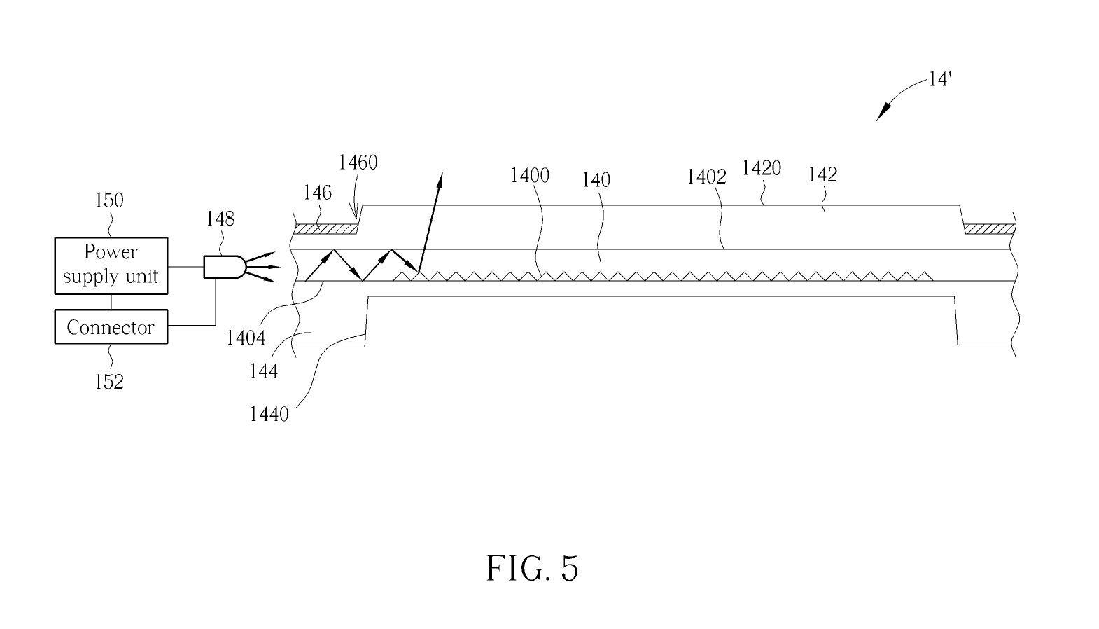

Referring to FIG. 5, FIG. 5 is a partial cross-sectional view illustrating a protective cover 14′ according to another embodiment of the invention. The difference between the protective cover 14′ and the aforesaid protective cover 14 is that the protective cover 14′ further comprises a connector 152 electrically connected to the light source 148 and the power supply unit 150 and used for connecting an electronic device (e.g. computer) or a power socket. In practical applications, the connector 152 may be a Universal Serial Bus (USB) connector or other connectors. In this embodiment, the user can use a cable to connect the connector 152 and the electronic device (e.g. computer) or the power socket, so as to supply power for the light source 148 or charge the power supply unit 150. It should be noted that the same elements in FIG. 5 and FIG. 3 are represented by the same numerals, so the repeated explanation will not be depicted herein again.

As mentioned in the above, when the protective cover of the invention is disposed on the keyswitches, the protective cover covers the gaps between the keyswitches to prevent particles, dust, liquids or the like from entering the interior of the keyboard through the gaps, so as to achieve dustproof function and waterproof function. In addition to dustproof function and waterproof function, the protective cover of the invention further has light emitting function. When the protective cover of the invention is disposed on the keyswitches, the keyboard becomes an illuminated keyboard, so as to enhance visual effect in use. Since the protective cover with light emitting function can be detached from the keyboard, it is favorable to miniaturize the keyboard.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protective cover comprising:
a light guide plate having a light scattering structure, an upper surface and a lower surface opposite to the upper surface, the light scattering structure being formed in the light guide plate and adjacent to the lower surface;
a first flexible layer formed on the upper surface, a refractive index of the first flexible layer being smaller than a refractive index of the light guide plate and larger than a refractive index of air;
a light masking layer formed on the first flexible layer, the light masking layer having a light transmissible portion formed over the light scattering structure correspondingly; and
a light source disposed neighboring to the light guide plate, light emitted by the light source being guided by the light guide plate and then emitted out of the light transmissible portion.

2. The protective cover of claim 1, further comprising a second flexible layer formed below the lower surface, a refractive index of the second flexible layer being smaller than the refractive index of the light guide plate and larger than the refractive index of air.

3. The protective cover of claim 1, wherein the light scattering structure forms a character, a symbol, a letter or a combination thereof.

4. The protective cover of claim 1, wherein the first flexible layer has a character, a symbol, a letter or a combination thereof corresponding to the light transmissible portion.

5. The protective cover of claim 1, wherein the refractive index of the light guide plate is between 1.4 and 2.

6. The protective cover of claim 1, wherein the first flexible layer has a protruding portion exposed from the light transmissible portion and corresponding to the light scattering structure.

7. The protective cover of claim 6, wherein the protruding portion has a character, a symbol, a letter or a combination thereof.

8. The protective cover of claim 2, wherein the second flexible layer has a recess portion corresponding to the light scattering structure.

9. The protective cover of claim 2, wherein the second flexible layer has a reflective layer formed below the light scattering structure correspondingly.

10. A keyboard comprising:
a baseplate;
a plurality of keyswitches disposed on the baseplate; and
a protective cover disposed on the keyswitches, the protective cover comprising:
a light guide plate having an upper surface and a lower surface opposite to the upper surface;
a first flexible layer formed on the upper surface;
a light masking layer formed on the first flexible layer, the light masking layer having a plurality of light transmissible portions formed over the keyswitches correspondingly; and
a light source disposed neighboring to the light guide plate, light emitted by the light source being guided by the light guide plate and then emitted out of the light transmissible portions.

11. The keyboard of claim 10, wherein the light guide plate further has a plurality of light scattering structures corresponding to the keyswitches, formed in the light guide plate and adjacent to the lower surface, the light emitted by the light source is scattered by the light scattering structures and then emitted out of the light transmissible portions.

12. The keyboard of claim 10, wherein a refractive index of the first flexible layer is smaller than a refractive index of the light guide plate and larger than a refractive index of air.

13. The keyboard of claim 10, wherein the protective cover further comprises a second flexible layer formed below the lower surface, and a refractive index of the second flexible layer is smaller than a refractive index of the light guide plate and larger than a refractive index of air.

14. The keyboard of claim 10, wherein the first flexible layer has a plurality of protruding portions exposed from the light transmissible portions and corresponding to the keyswitches, a concave space is formed between every two adjacent protruding portions, such that a user is able to distinguish different protruding portions corresponding to different keyswitches easily through the concave space.

15. The keyboard of claim 14, wherein each of the protruding portions has a character, a symbol, a letter or a combination thereof.

16. The keyboard of claim 10, wherein the protective cover further comprises a second flexible layer formed below the lower surface, and the second flexible layer has a plurality of recess portions corresponding to the keyswitches.

17. The keyboard of claim 16, wherein each of the keyswitches comprises a key cap; when the protective cover is disposed on the keyswitches, each of the recess portions covers one of the key caps, so as to restrain the protective cover from moving leftward and rightward.

18. A keyboard comprising:
a baseplate;
a plurality of keyswitches disposed on the baseplate; and
a protective cover disposed on the keyswitches, the protective cover comprising:
a light guide plate having an upper surface and a lower surface opposite to the upper surface;
a light masking layer formed above the light guide plate, the light masking layer having a plurality of light transmissible portions formed over the keyswitches correspondingly;
a second flexible layer formed below the lower surface, the second flexible layer having a plurality of recess portions corresponding to the keyswitches; and
a light source disposed neighboring to the light guide plate, light emitted by the light source being guided by the light guide plate and then emitted out of the light transmissible portions.

19. The keyboard of claim 18, wherein each of the keyswitches comprises a key cap; when the protective cover is disposed on the keyswitches, each of the recess portions covers one of the key caps, so as to restrain the protective cover from moving leftward and rightward.

20. The keyboard of claim 18, wherein the second flexible layer has a plurality of reflective layers formed below the light scattering structures correspondingly.
